(19) United States
(12) Patent Application Publication
(10) Pub. No.: US 2003/0033385 A1
(43) Pub. Date: Feb. 13, 2003

(54) System and method for utilizing broadcast synchronized data triggers

(76) Inventor: Edward Q. Yavitz, Rockford, IL (US)

Correspondence Address: Robert A. Van Someren, Fletcher, Yoder & Van Someren, P.O. Box 692289, Houston, TX, 77269-2289, US

(21) Appl. No.: 10/205,213

(22) Filed: Jul. 25, 2002

Related U.S. Application Data
(63) Continuation-in-part of application No. 09/484,334, filed on Jan. 18, 2000, now Pat. No. 6,463,469.

(51) Int. Cl. G06F 15/16

(52) U.S. Cl. 709/219

(57) ABSTRACT

A method and system for receiving remotely generated trigger signals via various wireless and broadcast standards is presented. The trigger signals are received by an information retrieval system comprising a memory and an accessible data storage location. The trigger signal allows the processor to selectively access information on the data storage location.

### CROSS REFERENCE TO RELATED APPLICATIONS

This patent application is a continuation-in-part of patent application Ser. No. 09/484,334, filed Jan. 18, 2000, entitled, “Computer-Based RDS/MBS Receiver System For Use With Radio Broadcast Signal”.

### FIELD OF THE INVENTION

The present invention relates generally to a system and method for selectively retrieving information from a store of information using a remotely generated data trigger. The stored information and data trigger may correspond to a radio, television, or satellite broadcast or to a signal generated on a wireless network.

### BACKGROUND OF THE INVENTION

Radio broadcasts, such as FM radio broadcasts, have long been used for the broadcast of information, such as music and commentary. Traditionally, the FM broadcast signal has been received on a receiver, such as a radio or stereo, that converts the broadcast signal to audible information. With the expansion of the Internet and the accompanying dissemination and availability of information, radio broadcasters have been seeking methods to convey additional information related to the primary programming. It is desirable for such additional information to be available, in both visual and audible formats, to both handheld and mobile electronic devices as well as to personal computers.

Proposals have been formed for providing radio content, including voice and music, over the Internet. However, bandwidth in the current infrastructure is largely inadequate for the high quality transfer of data that can be audibly played at, for example, an individual's personal computer. Others have attempted to transfer digital data via the radio data system standard (RDS, also know as RBDS) and/or the data radio channel (DARC) standard. However, only a limited amount of data can be transferred in this manner, e.g. less than 1 kilobyte/second (kbs) for RDS and 16 kbs for DARC, and radio stations, as well as end users, have been slow to utilize this limited RDS and DARC capability.

The RDS and DARC standards can be used to encode and decode digital data on an FM multiplexed signal for transmission and reception along with the primary FM broadcast signal. Both RDS and DARC are common FM subcarrier signals. Both allow the encoding and transmission of digital data on an FM carrier propagated over the airwaves. Radio stations, for instance, use the RDS standard to transmit limited digital data, such as station call letters or music type, to receivers of a corresponding FM signal.

It would be advantageous to utilize the limited data transfer capabilities according to the RDS and/or DARC standards in a manner that permitted recipients to gain access to a variety of substantial information related in real time to the programming on the corresponding primary FM carrier without requiring the recipient to be on the Internet.

### SUMMARY OF THE INVENTION

The present invention relates generally to an information retrieval technique utilizing a processor and an associated memory for storing information. The associated memory may be either local or remote. The technique further uses a reception component configured to receive a data stream in a broadcast or network format which may be synchronized with a primary media broadcast, such as television, radio, or the Internet. The data stream provides a trigger that allows an individual or device to automatically access information stored in an integrated memory storage element in relation to specific content being broadcast at a given time. Alternatively or in addition, the trigger may relate to an associated global positioning system (GPS) or to the current configuration of the receiving device. The information may be applied or accessed by various means including visual, audible or some combination thereof.

### BRIEF DESCRIPTION OF THE DRAWINGS

The invention will hereafter be described with reference to the accompanying drawings, wherein like reference numerals denote like elements, and:

FIG. 1 is a perspective view of an exemplary personal computer system having a receiver for receiving data via FM signal radio waves;

FIG. 2 is a schematic diagram depicting components of an exemplary receiver system for use in a personal computer;

FIG. 3 is a schematic diagram similar to that of FIG. 2 but showing various memory locations for storing data related to a particular FM radio broadcast;

FIG. 4 is a schematic diagram representing one exemplary topology for the overall system described herein;

FIG. 5 is a diagram similar to that of FIG. 4 showing various wireless, exemplary topologies;

FIG. 6 is a diagram depicting a representative group of various processor-based devices which might be employed in the various wireless topologies;

FIG. 7 is a diagram of a graphical user interface that permits a user to simultaneously utilize a personal computer and obtain information related to a current FM radio broadcast; and

FIG. 8 is a diagram similar to that of FIG. 7, but showing the present systems capability for retrieving information related to the current FM radio broadcast while utilizing or obtaining other information, such as that available over the Internet.

### DETAILED DESCRIPTION OF THE EXEMPLARY EMBODIMENTS

The following description is of a processor-based system, such as a personal computer, that allows a user to readily access information related to the audio, e.g. music, television, or other broadcast signals. As personal computers, home entertainment systems, and mobile electronic devices advance, there may be integration of these diverse systems via various communications means and protocols. The systems described below can be adapted to and envision such changes.

One exemplary existing system that can be used in conjunction with the inventive system described below is a combined radio and personal computer as described in McCoy et al., U.S. Pat. No. 5,790,958, issued Aug. 4, 1998 and entitled Radio Reception System For General Purpose Computer. The McCoy et al. patent describes a design for a radio receiver card that may be plugged into a personal computer to permit a user to receive and play radio broadcasts on his or her computer. The McCoy et al. system also receives and decodes RDS and/or MBS data transmissions in the FM stereo tuner mode and is able to display the RDS and/or MBS data on the monitor of the computer. However, the McCoy et al. patent does not disclose how to utilize the relatively small amounts of RDS and/or MBS digital data as a trigger to obtaining relatively large amounts of data related to the programming being played on a given radio station at a given time.

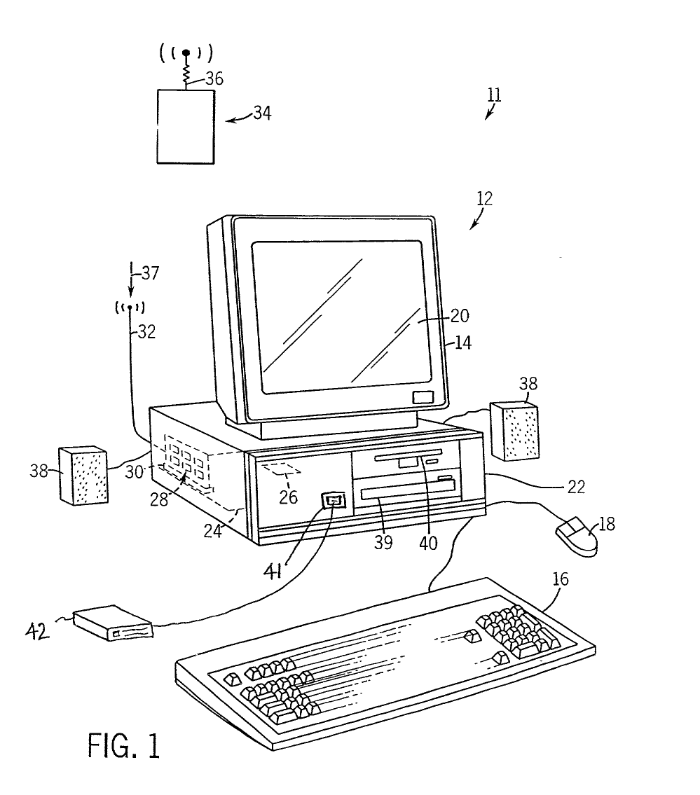

Referring generally to FIG. 1, a processor-based system 10 is illustrated according to an exemplary embodiment of the present invention. In this exemplary embodiment, system 10 includes a personal computer 12 having a user interface that may include a monitor 14, a keyboard 16 and a mouse 18. Monitor 14 may have a variety of forms, including CRT or flat screen displays. However, monitor 14 typically includes a display screen 20 for displaying a variety of information to the user.

Personal computer system 12 also includes a housing 22 containing a motherboard 24 upon which a variety of computer circuit components, including a processor 26, are mounted. Additionally, a reception system 28 is coupled to the motherboard 24. Reception system 28 includes, for example, an FM tuner and digital data decoder card 30 that is connected to motherboard 24, as shown. Card 30 may be a printed circuit board style card configured for pluggable engagement with personal computer 12 at, for example, a PCI slot. Reception system 28 also includes a reception antenna 32 that is attached to FM tuner and digital data decoder card 30 to receive FM signals transmitted over the airwaves from a radio broadcast station 34 having a broadcast antenna 36.

In the exemplary embodiment illustrated, FM radio signals are processed by the computer 12 for playback of audio signals through one or more speakers 38 attached to computer 12. Computer 12 also processes any RDS and/or DARC digital data received from the FM transmission. This RDS/DARC data contains a digital or data trigger 37 that provides a prompt on display screen 20 to a user and permits the user to automatically obtain additional information about the music or other programming being broadcast on the primary FM radio signal via radio station 34. The additional information which has been stored prior to the broadcast, for example, can be liner notes to the music containing information related to the musician or musicians responsible for the music being played, additional information about upcoming concerts, weblinks to the musicians or to Internet CD vendors whereby the listener can order the music as it is heard with a single click of the mouse. Other prompts that may appear on screen include information related to an advertisement or products/services advertised, information about commentators or disc jockeys providing commentary, etc. The programming code included with the previously downloaded material allows the listener to establish accounts with advertisers or CD vendors in order to make split second purchasing decisions when prompted by the music or advertised offers. The radio reception system 10 permits the user to obtain this information automatically as the programming takes place.

It should be noted that the exemplary personal computer 12 also includes a CD drive 39, a floppy disk drive 40, and a USB or Firewire port 41. The port 41 allows for external memory devices 42 such as memory sticks and external hard drives to be attached to the computer. CD drive 39, disk drive 40, and external memory devices attached via port 41 provide potential locations for storage of data or for the downloading of data related to the programming of a given radio station 34, as explained in more detail below.

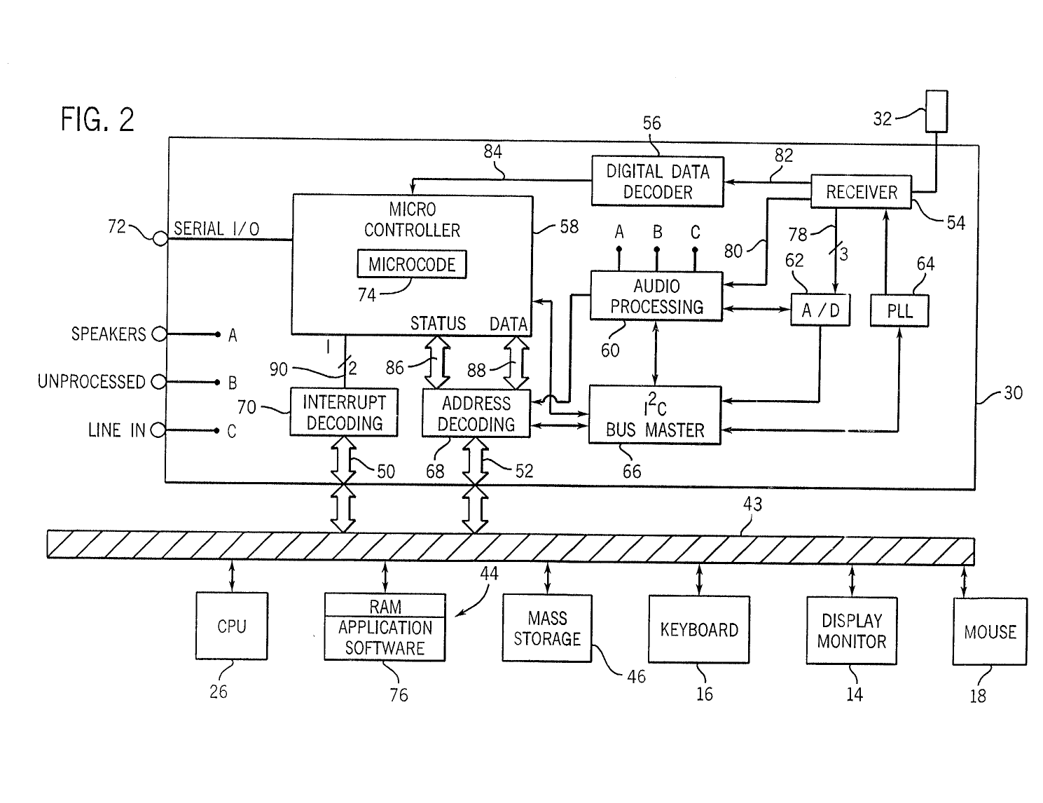

A substantially exemplary implementation of reception system 28 and as described in U.S. Pat. No. 5,790,958 is discussed with reference to FIG. 2. In this exemplary embodiment, FM tuner and processing card 30 is connected via a bus 43, such as an ISA bus, to the components of a personal computer. The main personal computer components include a central processing unit (CPU), such as processor 26. Additionally, personal computer 12 includes a RAM memory unit 44, a mass storage unit 46, keyboard 16, display monitor 14 and mouse 18. It should be noted that it is possible to externally mount card 30 outside of personal computer 12 and connect the processing card to the computer via an external interface. Processing card 30 interfaces with bus 43 through a group of interrupt lines 50 and a group of address and data lines 52. Card 30 comprises a receiver and tuner unit 54 which is connected to antenna 32. Receiver 54 is connected to a digital data decoder 56 which, in turn, is connected to a digital data processor or microcontroller 58. The receiver 54 also is connected to an audio processing unit 60, an analog to digital converter 62 and a phased loop logic (PLL) circuit 64. A local bus controller 66, such as an I²C bus master, is connected to the devices 58, 60, 62 and 64 as shown, and is also connected to address decoding circuitry 68. The address decoding circuitry 68 and an interrupt decoding circuitry 70 are both connected to the microcontroller 58.

Processing card 30 also contains an external serial port 72 connected to microcontroller 58. Card 30 also includes three audio ports labeled A, B and C, connected to the audio processing unit 60. Audio port A is an audio output port for connection to external speakers. Audio port B is an unprocessed audio port for connection to a sound card or other audio device. Audio port C is an input port or “line-in” port for receiving audio signals to be processed by the audio processing unit 60.

In operation, processing card 30 performs standalone functions dictated by software or microcode 74, which is resident within the microcontroller 58. Microcontroller 58 may be a standard 8051 device operating a 12 MHz. Additional functions of the processing card 30, as well as processing functions of the radio data reception system, are controlled by an application software 76 resident in the associated personal computer 12 and which may be stored in the mass storage device 46 and loaded into the computer's memory unit 44 during operation. By sharing processing functions between the card microcontroller 58 and the computer processor 26, performance of the overall system can be enhanced and optimized to take advantage of the more powerful host CPU.

Communication between the various devices of processing card 40 may be accomplished via a local 2-bit I²C bus. In the exemplary embodiment, local bus access is controlled through the I²C bus master chip 66. It should be noted that it is also possible to configure the microcontroller 58 as the bus master, thereby eliminating the need for separate bus master chip 66.

Tuning information received from the application software 76, via bus 43, is routed through the I²C bus master 66 and to the PLL 64. Similarly, audio processing parameters are routed to the audio processing unit 60 via the bus master 66. The receiver 54 locks onto the desired FM station and emits corresponding signals along paths 78, 80 and 82.

Along the data path 78, three separate signals are transmitted indicating the strength of the detected audio signal and the levels of the left and right stereo signals. This information is then digitized by the A/D converter 62 and then transferred back through bus 43 for processing and display by the application software 76. The signal containing the analog audio information is transmitted along the path 80 for further processing by the circuitry 60 before being output to the audio port A. The audio signal also is transmitted along path 82 to the digital data decoder 56. The digital data decoder 56 demodulates and decodes the digital subcarrier data (either RDS or DARC) associated with the particular FM station which is tuned by receivers 54.

The digital data decoder 56 may be any number of standard decoding devices. In an exemplary embodiment, a Phillips brand model SA6574T is used. The digital data decoder 56 outputs a continuous digital data stream, and corresponding clock signal, along a path 84 for reception by microcontroller 58 for analysis and processing.

The microprocessor performs a sequence of operations to identify, decode, store and eventually transmit the RDS and/or DARC data along bus 43 to the host personal computer. In the exemplary embodiment, if microcontroller 58 detects RDS data, it automatically decodes the RDS data. Similarly, if the microcontroller 58 detects DARC data, it automatically decodes the data.

Communication between microcontroller and the host personal computer, or other display/processing system is accomplished via a status port having corresponding signal lines and a data port having a corresponding signal line 88. Depending on the particular microcontroller, the data and status ports may be onboard or implemented with an external I/O device. In the exemplary embodiment, the data and status ports are 8-bit registers and the signal lines 86, 88 each contain corresponding eight individual signal paths. The status signal lines 86 serve to identify the current transfer operation performed by the microcontroller 58, and the data signal lines 88 transfer the data from the microcontroller 58 to the host computer. The data and status information from the corresponding ports is decoded by the address decode circuitry 68 and presented to the bus 43 for transfer to the host computer.

Interrupt decoding information is transferred from the microcontroller 58 to the interrupt decoding circuitry 70 along a path 90. When the microcontroller 58 wishes to interrupt the host computer, interrupt signals are processed by the decoding circuitry 70 and presented to the bus 43 over the signal lines 50. Data transfer between the microcontroller 58 and the host computer can be accomplished by an “interrupt” method or a strict “polling” method, as discussed in U.S. Pat. No. 5,790,958. Additionally, because processing card 30 may be exposed to the surrounding circuitry of the host computer, RF shielding of the card or individual components may be required to avoid interference with the audio information processed by card 30.

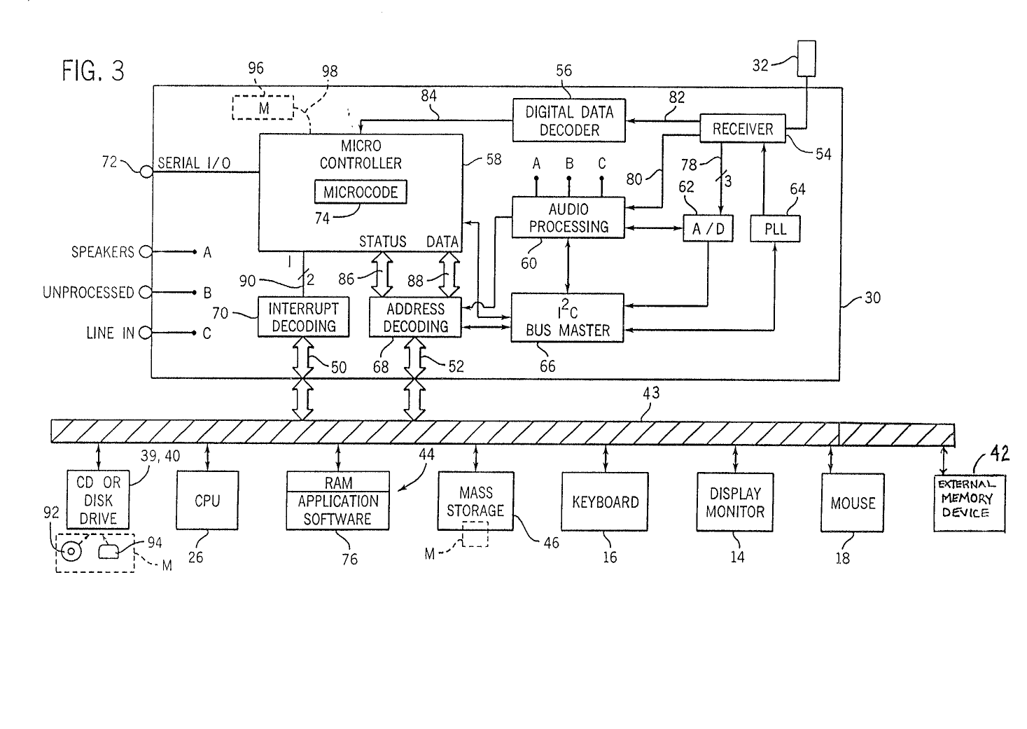

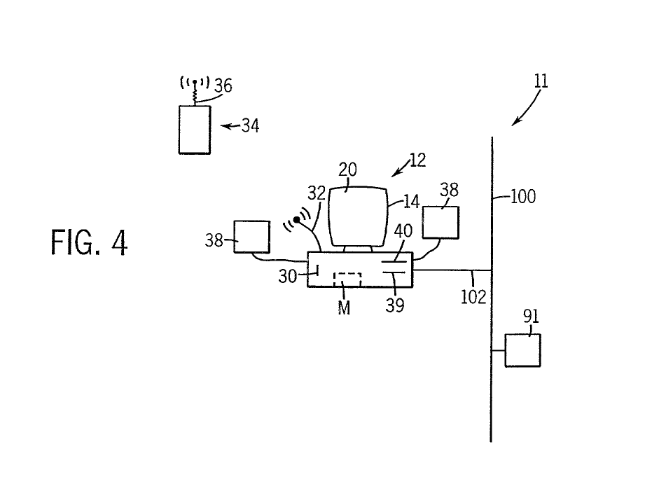

One of the problems with systems or methodology for utilizing RDS and/or DARC is the relatively limited amount of data that can be carried by the RDS and/or DARC signal. Thus, only small amounts of information related to the radio programming can be transferred by such mechanisms. Accordingly, the present invention embodied in radio reception system 10 utilizes the RDS and/or DARC signal as a data trigger 37 for obtaining additional information stored at a location M (see FIG. 3) accessible to personal computer 12. Exemplary storage locations M include a CD 92 or floppy disk 94 utilized in conjunction with CD drive 39 or disk drive 40, respectively; mass storage 46, such as a personal computer hard drive; a memory module 96 mounted on processing card 30 and accessible to microcontroller 58 via line 98; and an external memory device 42, such as a memory stick or external hard drive, connected via USB port 41. The information can also be downloaded over a network, e.g. the Internet, to a storage location M, such as a computer hard drive. Potentially, storage location M can be at a remote network location, such as on a server 91, as illustrated in FIG. 4.

According to one exemplary methodology, a CD 92 or a floppy disk 94 is supplied to a radio station's listeners. The CD 92 and/or floppy disk 94 typically contains information related to the radio station programming. For example, there may be substantial information related to the music and musicians played by the radio station during a given time period. Additionally, there may be data related to the station's advertisers including information relating to products, services and the ordering of such products and services. The stored information may be textual, graphical, or audio in nature.

When the user receives disk 92 or 94, he or she simply inserts it into CD drive 39 or disk drive 40 and downloads the information to the disk drive of the computer, i.e. mass storage 46. (As mentioned above, the overall system can be designed to store the subject information in a variety of locations.) Depending on the specific location, the data trigger 37 carried on the RDS or DARC signal is designed to facilitate location of relevant data from the stored information for viewing by the user. It should be noted that the relevant information can also be downloaded over the Internet from, for example, a radio station website.

Alternately, the data trigger 37 may be transmitted and received by means other than an FM subcarrier signal. For example, the data trigger 37 may be sent and received via other wireless and broadcast platforms, such as cellular (SMS, etc.), satellite, digital radio, 802.11, Bluetooth or over an Internet webcast. An alternate data trigger 37 is synchronized with the broadcast, similar to a data trigger 37 carried on a subcarrier signal. Indeed, various data trigger mechanisms may be simultaneously employed in conjunction with a broadcast, differing only in the manner in which they are propagated. It is understood that, if the Internet is utilized to propagate the data trigger 37, the broadcast itself may also be received over the Internet via simultaneous webcast. Indeed, in this situation, the broadcast, and the data trigger 37 may both be received via the Internet and the accessible mass storage location, M, may indeed be a file on a server associated with the broadcast.

As described more fully below, when the data trigger 37 is received, the user is provided with a prompt at display screen 20. Upon clicking the prompt by, for example, mouse 18 the stored information is accessed in storage location M, e.g. mass storage 46. Preferably, the data trigger 37 is addressed to correspond to the storage location of particular information related to the actual programming being broadcast at that time. Thus, if the individual is listening to a song of particular interest on the radio data reception system 28, the data trigger can be used, via the prompt on display screen 20, to access textual, graphical, or audible information related to the specific song or group performing the song. For example, musical selections played by a given radio station may be cataloged according to their CDDB unique identification numbers, and the data trigger can contain corresponding identification data to locate the specific relevant information from storage location M. The format and utilization of a data trigger depends on the overall design of radio reception system 10 and the preferred storage location for the information, but it is within the skill of one of ordinary skill in the art.

It should be noted that receiver 54 typically is designed to receive radio signals, e.g. FM radio signals, transmitted from one radio station or a limited number of radio stations within a related group. This allows the particular radio station or stations to provide information related to their specific programming for access by an individual listening to the station's programming. If one station's FM subcarrier signals are not available, the data triggers 37 may be sent by other FM subcarriers or other wireless and broadcast platforms. Examples of such wireless platforms include cellular, satellite, digital radio, 802.11, and Bluetooth. In addition, the Internet may also be utilized to provide the data triggers 37.

Another advantage of the system described with reference to FIG. 3 is the ability of the system to provide a user with current information related to the FM programming to which he or she is listening, while simultaneously permitting access to unrelated information over a network 100, such as the Internet (see FIG. 4). In the topology illustrated in FIG. 4, a combined personal computer system 12 and radio data reception system 28 is provided for receiving a primary FM radio broadcast signal as well as a subcarrier signal or other data trigger signal 34. Simultaneously, personal computer 12 is coupled to network 100, e.g. the Internet, via an appropriate modem and connection 102. Thus, an individual can simultaneously utilize personal computer 12, listen to an FM radio broadcast from radio station 34, obtain and send information over network 100, and access relatively large amounts of data from memory location M that is related to the programming being broadcast at that given time.

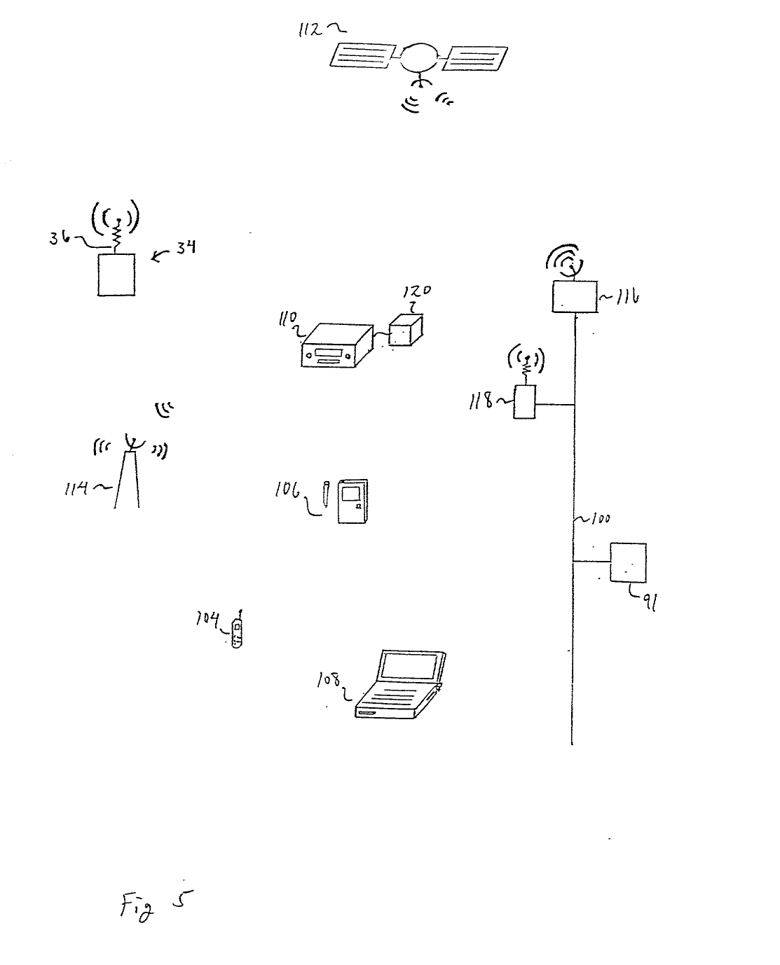

Even though the system illustrated in FIG. 4 is an exemplary system, the overall system 10 can have a variety of designs and topologies. As illustrated in FIG. 5, for example, various processor-based systems can be utilized in conjunction with general principles discussed above. For example, a cellular phone 104, personal digital assistant (PDA) 106, wireless-networked computer 108, or mobile radio 110, such as a car radio, all may incorporate the necessary components to practice the above techniques. Numerous electronic devices, such as those listed, possess the capability to receive radio, television, or other broadcasts, either directly or via the Internet. In addition, a data trigger 37 may also be received by electronic devices receiving a broadcast transmission.

The data trigger 37 may be received as a subcarrier of the broadcast signal, as discussed above. In addition, the data trigger 37 may be sent to the various electronic devices by alternative means including as a cellular signal received from a satellite 112 by cellular tower 114 which then propagates the signal. In addition, the satellite 112 may provide digital satellite communications services, such as digital radio or satellite broadband Internet access. In such instances, the data trigger 37 may be received directly from a satellite signal by the various electronic devices. For instance, the satellite 112 may relay information from the network 100 received from transmitter 116. Wireless Internet connections may also be established between the various electronic devices and the Internet via a wireless network node 118 utilizing a communications protocol such as 802.11 or Bluetooth. Obviously wire-based connections may also be utilized, particularly when a personal computer 12 based system is employed as in FIG. 4. Mobile electronic devices, such as those represented in FIG. 5, may require the types of wireless connection described. In this manner, a mobile electronic device may receive a data trigger 37 of the type discussed above as a component of the radio transmission from broadcast antenna 36 or as a separate transmission via satellite 112, cellular transmitter 114, or network node 118.

In another exemplary use of this invention, a GPS transponder 120 may also be associated with the various electronic devices such as mobile radio 110, cell phone 104, or PDA 106. The combination of location information and the data trigger 37 may allow for specific or customized messages to be accessed from memory location M at specific locations and in conjunction with the primary broadcast. For example, an advertisement for a local retailer or restaurant could include a subcarrier data trigger which, when combined with a GPS transponder location, provides the address of the nearest location. Similarly, general weather or traffic messages, such as “delays ahead” or “lane closure ahead” might be accessed from the memory location by the appropriate combination of location information and data triggers 37.

In addition, in an exemplary embodiment, information to be accessed may be stored in the form of a .wav file, MP3 file or other audio file format. The processor-based system, by executing a stored routine, then mutes the radio and/or plays the appropriate pre-stored audio file to audibly alert the driver when such an alert is warranted. A small subcarrier signal, for example, is utilized to trigger the delivery of pre-stored information for the driver without creating a visual distraction.

While the above exemplary embodiment clearly covers automobiles and automobile radio systems, non-automobile configurations also benefit. For example, a cell phone 104 or PDA 106 may be equipped with a GPS transponder 120 to provide location specific information. For instance, cell phones 104 and PDSs 106 so equipped are able to provide location specific weather information in the event of severe weather warnings. Similarly, the cell phone 104 or PDA 106 are able to provide restaurants or other attractions in a location specific manner based upon a data trigger 37, as described above. Such systems deliver the pre-stored information in an audible form when appropriate.

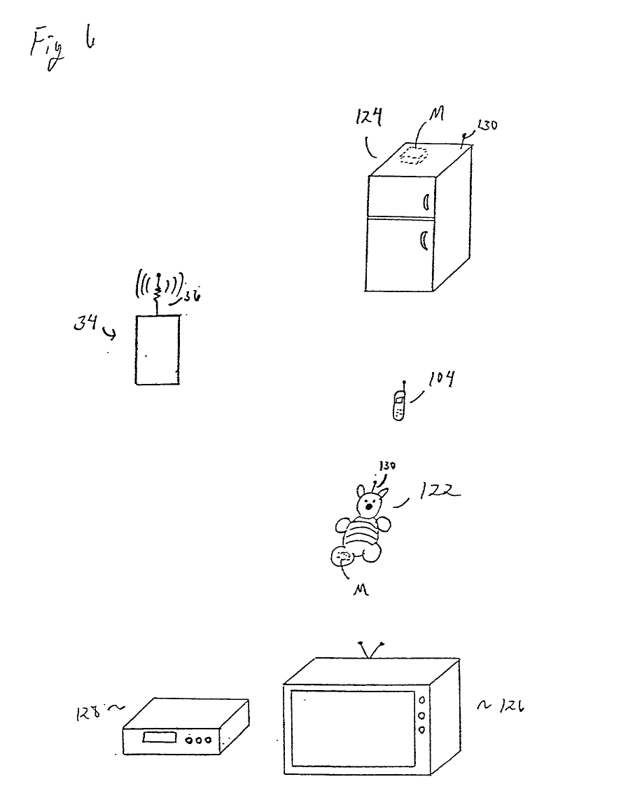

Further, as depicted in FIG. 6, various electronic devices, including toys 122, household appliances 124, entertainment systems, such as television 126 and VCR 128, and mobile systems and electronic devices, such as cell phone 104, are constructed with processors, software, and limited memory storage. These devices may be constructed with a rewritable memory chip and are not designed to connect to the Internet. By incorporating inexpensive FM subcarrier receiver 130 into these devices, along with some form of accessible memory location, M, manufacturers can communicate with these remote devices using broadcast FM subcarrier signals or any of the alternative wireless, cellular, satellite, or network data triggers 37 discussed herein. Such communications may include adjusting software configurable settings, upgrading or updating such a configurable file, calibrating device performance, performing diagnostic testing, or other performance enhancing modifications.

For example, an exemplary mobile electronic device able to practice this technique is a toy doll 122 interactive with an Internet site or television/radio media broadcast. With an inexpensive memory chip, here shown at memory location M, and RDS receiver 130, the doll 122 is able to interact with a media broadcast in real time. In the example of a television broadcast, the characters on the television broadcast could ask the doll 122 a question. Radio or satellite broadcasts of a data trigger 37 would initiate the doll's memory and evoke a pre-recorded response held in the doll's memory. In the example of an Internet website or webcast, the doll 122 may be configured to receive a specific subcarrier signal which is broadcast to coincide with the website. The data trigger 37 also can be used to configure the doll 122 to receive and play an audio band of the subcarrier, i.e. to play an audio broadcast directly, instead of playing pre-recorded audio files.

By utilizing a rewritable memory chip, the responses may be loaded to memory via RDS or other wireless means prior to the program which evokes the responses. In this manner, specific responses, such as for educational programs and questions, may be stored in the memory of the toy as well as generalized responses.

Other examples of processor-based devices that benefit from these techniques are illustrated in FIG. 6. For example, the appliance 124, here represented as a refrigerator/freezer unit, may possess configurable settings stored within a memory element M which can be adjusted via a data trigger 37. For instance, a data trigger is transmitted by any of the means disclosed above such that freezer 124 makes more ice when a certain data trigger 37 is received, e.g., as when a weather forecast is for higher temperatures. Similarly, television 126 may be automatically reconfigured to display a picture in wide-screen format in the presence of an appropriate data trigger 37. Likewise, a configurable parameter, such as record speed, may be adjusted on VCR 128 in the presence of an appropriate data trigger 37. By these means, a processor-based device, such as those depicted, may benefit from a data trigger 37 transmitted concurrent with a primary broadcast by the simple addition of a receiver component such as FM receiver 130 and a memory location M.

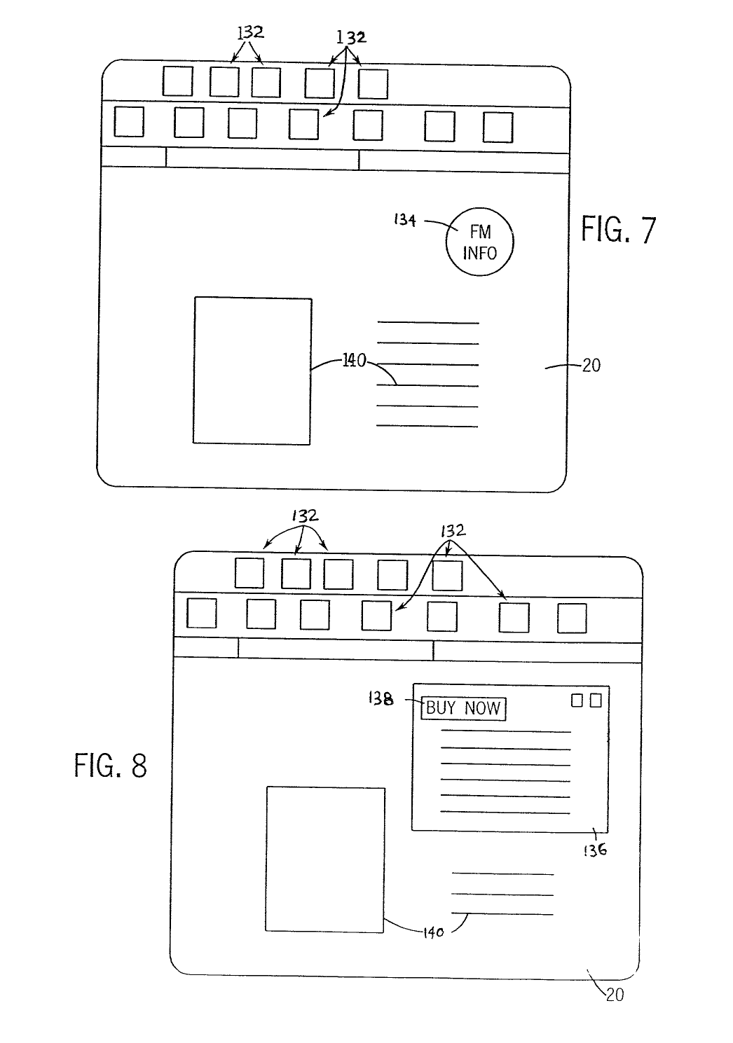

One way of interacting with a computer based system is as follows. Referring generally to FIGS. 7 and 8, exemplary display screens are illustrated as might be present on a processor based system including a personal computer 12 or other electronic device utilizing graphical displays, such as the PDA 106 or cell phone 104. Although a variety of graphical user interfaces may be utilized, a typical personal computer interface utilizes a Windows-style screen having a plurality of prompts 132 that allow the user a “point and click” format to interface with the personal computer. For example, as is commonly known, a mouse can be used to move a cursor and click on the various indicators or prompts. Similarly, an exemplary embodiment of the present invention utilizes a prompt 134 that is visible on display screen 20 when subcarrier signals are being received via radio data reception system 28.

The application software permits a user to simply point and click on prompt 134 to obtain access to the information stored in memory location M and related to the primary programming broadcast by radio station 34. When an individual points and clicks on prompt 134, a desired stored information 138 is displayed on screen 20, as illustrated in FIG. 8. Preferably, the data trigger carried by the subcarrier signal also contains address/file/desired information, e.g. CDDB identifiers, related to specific subject matter of the primary FM broadcast being received at that specific time. Thus, when the individual clicks on prompt 112, he or she is provided with information 114 that is specifically related to the then current programming. As mentioned, the listener can establish accounts with Internet CD vendors or advertisers so that by clicking on a box 138 labeled, for example, “Buy now” on their personal computer monitor, an order will be placed for the song or advertised item as it is heard using unique identification numbers assigned to products, services or music selections and broadcast over the RDS or DARC system.

Also, the storage of information related to the FM radio broadcast at storage location M permits a user to obtain information about the radio broadcast programming without interrupting other applications 140 being used on computer system 12. For example, the user may be sending or retrieving information over the Internet (network 100) while retrieving information related to a specific song or other programming without interrupting his or her utilization of the network. Potentially, this provides the user an efficient method for ordering information or products over the Internet that are related to the music, advertisements or other material being broadcast by FM radio station 34. This ability can be tremendously helpful for both the radio station and advertisers alike.

It will be understood that the foregoing description is of preferred exemplary embodiments of this invention, and that the invention is not limited to the specific forms shown. For example, a variety of radio wave receiver systems, computer systems and data triggers may be utilized; the form and arrangement of computing systems and entertainment systems may change while still incorporating the present invention; the circuitry and electrical components can be adjusted according to specific applications; and the information related to the FM broadcast can be stored in a variety of locations, including a networked location, although it is preferred that the information be stored in a location that does not require the interruption of network usage. These and other modifications may be made in the design and arrangement of the elements without departing from the scope of the invention as expressed in the appended claims.

What is claimed is:

1. An information retrieval system, comprising:
a processor;
a data storage location configured to store information to be selectively accessed by the processor upon receipt of a remotely generated trigger signal; and
a reception component configured to receive the remotely generated trigger signal transmitted according to at least one of a wireless and broadcast standard, the reception component being operatively coupled to the processor.

2. The information retrieval system as recited in claim 1, wherein the data storage location is on at least one of a hard drive, a rewritable memory chip, and a removable storage device.

3. The information retrieval system as recited in claim 2, wherein the removable storage device is at least one of a memory stick, a compact disk, and a diskette.

4. The information retrieval system as recited in claim 1, wherein the reception component is configured to receive the trigger signal synchronously with a media broadcast.

5. The information retrieval system as recited in claim 1, wherein the reception component is configured to receive the trigger signal via at least one of a wireless network standard, a cellular telephone standard, a satellite communication standard, and a digital radio standard.

6. The information retrieval system as recited in claim 5, wherein the wireless network standard comprises at least one of 802.11 and Bluetooth.

7. The information retrieval system as recited in claim 1, wherein the processor accesses the information by at least one of playing an audio file, displaying a text file, and displaying a graphics file.

8. The information retrieval system as recited in claim 1, wherein the processor accesses the information and thereby modifies one or more configurable parameters of an associated device.

9. The information retrieval system as recited in claim 1, wherein one or more files are transmitted to the system via a wireless or broadcast means and are written to the data storage location for later retrieval by the trigger signal.

10. The information retrieval system as recited in claim 9, wherein the processor accesses the one or more files and thereby modifies one or more configurable parameters of an associated device.

11. The information retrieval system as recited in claim 1, further comprising a location-determining component operatively coupled to the processor.

12. The information retrieval system as recited in claim 11, wherein the location-determining component is a GPS transponder.

13. The information retrieval system as recited in claim 11, wherein the processor selectively accesses the information by using a location determined by the location-determining component and the trigger signal.

14. A method for retrieving pre-stored information, comprising:
utilizing an information retrieval-system having a processor and a reception component to receive a data trigger transmitted via at least one of a wireless and broadcast standard;
storing data to be selectively accessed at a location accessible to the processor; and
accessing select data from the stored data according to the data trigger being transmitted at a given time.

15. The method as recited in claim 14, wherein storing data comprises storing data on at least one of a removable storage medium and a remote storage medium.

16. The method as recited in claim 14, wherein receiving the data trigger comprises receiving the data trigger via at least one of a wireless network standard, a cellular telephone standard, a satellite communication standard, and a digital radio standard.

17. The method as recited in claim 14, wherein accessing select data comprises at least one of playing an audio file, displaying a graphics file, displaying a text file, and adjusting a configurable parameter of an associated device.

18. The method as recited in claim 14, further comprising:
determining a location from a location-determining device operatively coupled to the processor; and
wherein accessing select data further comprises accessing the data according to the location in addition to the data trigger.

19. The method as recited in claim 18, further comprising:
playing an audio file, wherein the audio file comprises the select data.

20. An electronic device comprising:
a receiver component, wherein the receiver component is configured to receive a trigger signal transmitted simultaneously with a primary media broadcast;
a processor component;
a data storage component, wherein the processor component processes the trigger signal to play one or more audio files stored on the data storage component such that the audio file is played in apparent response to the primary media broadcast.

21. The electronic device as recited in claim 20, wherein the electronic device is a toy.

22. The electronic device as recited in claim 21, wherein the toy is a doll.

23. The electronic device as recited in claim 20, wherein the data storage component is at least one of a rewritable memory chip and a removable memory device.

24. The electronic device as recited in claim 20, wherein the data storage component is rewritten with audio files received via at least one of a broadcast signal, a wireless network signal, and a cellular signal.

25. The electronic device as recited in claim 20, wherein the primary media broadcast is at least one of a television, a radio, a satellite radio, and an Internet signal.
